(19) United States
(12) Patent Application Publication
(10) Pub. No.: US 2003/0052899 A1
(43) Pub. Date: Mar. 20, 2003

(54) Dynamic spatial warp

(76) Inventors: Diana Walczak, Williamstown, MA (US); Jeffrey Kleiser, Williamstown, MA (US)

Correspondence Address: Christopher J. McDonald, Esq., HOFFMAN, WASSON & GITLER, PC, Suite 522, 2361 Jefferson Davis Highway, Arlington, VA, 22202, US

(21) Appl. No.: 09/929,080

(22) Filed: Aug. 15, 2001

Related U.S. Application Data
(60) Provisional application No. 60/225,655, filed on Aug. 16, 2000.

(51) Int. Cl. G09G 5/00

(52) U.S. Cl. 345/647

(57) ABSTRACT

The process allows a moving audience to view a film or digital projection without distortion caused by the angle of the audience relative to the projection screen. The skewing of the image to accommodate for the distortion resulting from the audience's angle to the screen is distinctly different from the alternative method of “squinching”, a two-dimensional pixel manipulation method. Skewing accomplishes the necessary visual compensation at the virtual set stage, rather than a post process of the filmed final image. The process covers audience motion not in a plane tangent to the earth's surface or fixed surfaces. Distorting the three-dimensional geometry before rendering results in superior image resolution to the two-dimensional pixel manipulation approach. In the manipulation approach, an image is rendered from the audience point of view and the resulting pixels are mapped into corresponding positions in the film image. Pixel manipulation requires that image data be stretched or filled-in to complete the projected image. The three-dimensional geometric transformation of the invention enables a scene to be rendered at full resolution from the projector point of view. The technique is performed iteratively to accommodate a moving audience point of view. A pair of computer cameras for the audience point of view is used to present an undistorted moving audience stereoscopic imagery.

This application claims the benefit of provisional application Serial No. 60/225,655, filed Aug. 16, 2000.

### BACKGROUND OF THE INVENTION

Amusement rides often combine the rider's movement with graphics. The visual effects compliment and enhance the rider's experience on the amusement ride. Images are usually done in three-dimensional geometry for the most realism. Typically, the images are projected on a stationary screen from a stationary projector. The rider travels passed the screen, resulting in an ever-changing angle between the rider and the images projected on the screen. This angle causes distortion when the viewer's angle differs from the projector's angle relative to the screen. In a normal situation, the audience travels parallel to the screen between the projector and the screen. There is a need to render images that appear undistorted to the audience in order to maximize the audience's enjoyment of the images and enhancement of the amusement ride.

Prior art solutions to the problem of an audience having an ever-changing angle relative to a screen had been to form images on a film and, post process “squinching”. This process is expensive, time consuming and results in a loss of sharpness and resolution of the images.

It is an object of the invention to provide a method for forming undistorted images as seen from an audience point of view that is at an angle to the projection screen.

It is another object of the invention to provide images with high resolution and sharpness.

It is still another object of the invention to provide images seen from an obtuse audience point of view that is inexpensively produced.

It is yet another object of the invention to provide undistorted images from an obtuse audience point of view that can be fully rendered using computer software packages.

It is yet another object of the invention to provide a process for forming undistorted images that can be performed iteratively to accommodate a moving audience point of view having an ever-changing angle relative to a projected screen.

These and other objects of the invention will become apparent after consideration of the description of the invention.

### SUMMARY OF THE INVENTION

The process allows a moving audience to view a film or digital projection without distortion caused by the angle of the audience relative to the projection screen. The skewing of the image to accommodate for the distortion resulting from the audience's angle to the screen is distinctly different from the alternative method of “squinching”, a two-dimensional pixel manipulation method. Skewing accomplishes the necessary visual compensation at the virtual set stage, rather than a post process of the filmed final image. The process covers audience motion not in a plane tangent to the earth's surface or fixed surfaces. Distorting the three-dimensional geometry before rendering results in superior image resolution to the two-dimensional pixel manipulation approach. In the manipulation approach, an image is rendered from the audience point of view and the resulting pixels are mapped into corresponding positions in the film image. Pixel manipulation requires that image data be stretched or filled-in to complete the projected image. The three-dimensional geometric transformation of the invention enables a scene to be rendered at full resolution from the projector point of view. The technique is performed iteratively to accommodate a moving audience point of view. A pair of computer cameras for the audience point of view is used to present an undistorted moving audience stereoscopic imagery.

### BRIEF DESCRIPTION OF THE DRAWINGS

FIG. 1 depicts the skewing of a three-dimensional object from the audience point of view original geometry to the spatially warped geometry of the projector point of view; and

FIG. 2 depicts the correlation of the spatially warped geometry and front view of the projection image.

### DETAILED DESCRIPTION OF THE INVENTION

The invention creates three-dimensional computer generated images that are projected onto any shaped screen and viewed from a known position in front of that screen without visual distortion of the image as seen by the audience. The images are predistorted and projected onto the screen so that from the known position and angle of the audience, it will appear undistorted. This is achieved by a software data translation.

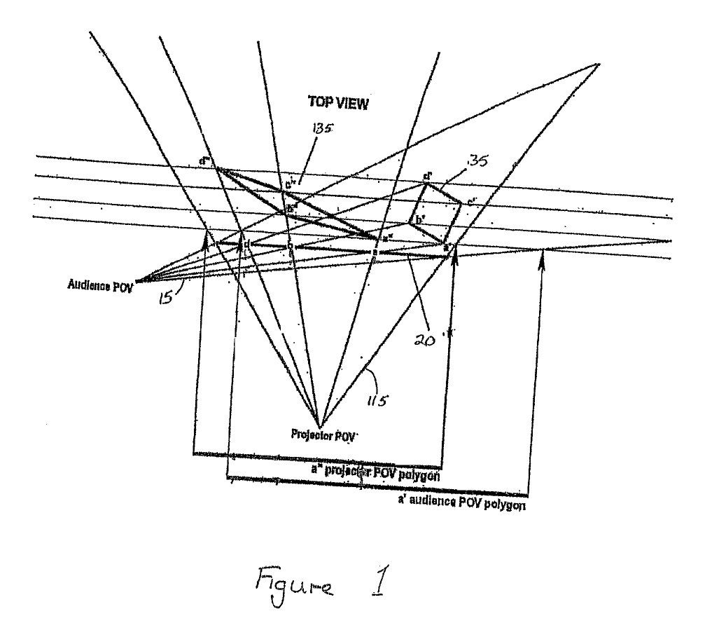

The predistortion is seen graphically in FIG. 1 with a simple polygon. Of course, the method can be applied to any shaped object. The first step is to determine the viewer location with respect to the screen. The angle between the audience's point of view and the screen will determine how much distortion is necessary. From the known audience position (POV), multiple three-dimensional rays 15 are extended from the audience position through the defining vertices of the screen 20 and beyond into the virtual world. This is seen in FIG. 1 as the audience POV is shown at a given location and the rays are projected through the screen to establish the audience cone of vision. Five rays are depicted; two rays intersect the edges of the screen and three rays intersect the vertices of the original geometry 35 in the polygon labeled as a′, b′, c′, d′. The rays for points b′ and c′ are coincident. This polygon establishes the vertex of the three-dimensional geometry in the virtual world. These vertices must be off-set, in position, in three-dimensional space so that they are translated from the position within the audience cone of vision to the equivalent position within the projector point of view.

The translation is shown as the projector POV is determined from the position of the projector. Rays 115 are extended from the projector, through the point of intersections of the audience POV rays with the screen (a, b, d). The projector rays are extended beyond the screen to the same distance as the vertices in the ordinary geometry of the audience polygon, resulting in the spatially warped geometry 135. This is shown in FIG. 1 as polygon a″, b″, c″, d″. It is also seen that the equivalent vertices a′, a″; b′, b″; c′, c″; and d′, d″ are at the same distance from the projector screen as delineated by the parallel lines behind the projector screen 20 of FIG. 1. It is noted that the b and c vertices are co-linear in the projector POV as they were in the audience POV.

Prior to translating the data in the virtual world into the warped position, it is necessary to cache or store information about the light positions in the virtual world for each surface to be rendered. This ensures that the angles of incident of the light sources in the scene are calculated based on the undistorted geometry rather than distorted geometry. The next step is to render the translated virtual world with standard computer graphic techniques using a computer simulation of a camera located at the projector position. These images are recorded onto film or video. The rendered images are displayed onto the screen or the rendered files are used as an input to a digital projection system to display them onto a screen.

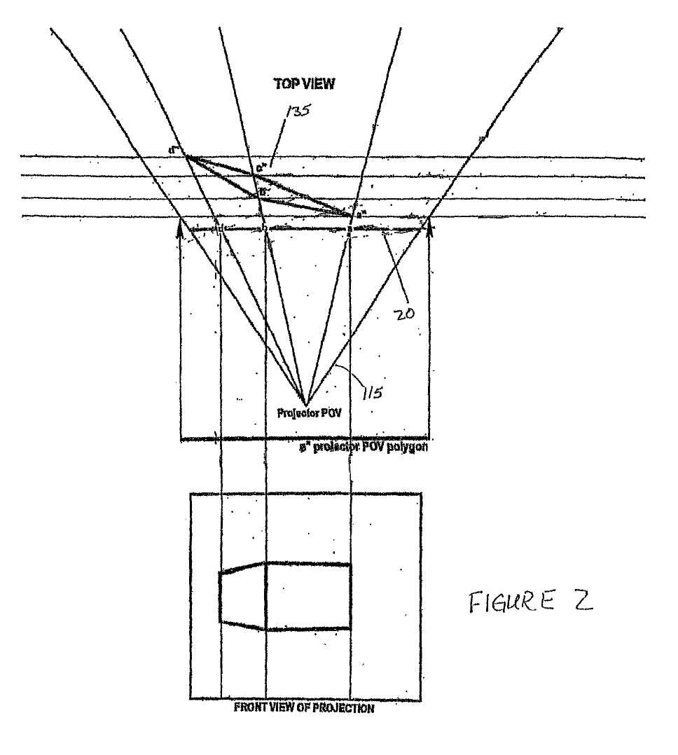

The translation of the spatially warped geometry 135 to the projector image of the screen 20 is seen in FIG. 2. When reviewed from the audience POV, the image appears undistorted as though the viewer is looking through a window into the virtual world as opposed to looking at a two-dimensional photograph of the virtual world. This technique could be used iteratively to accomplish a moving audience POV. In this instance, the audience POV is continuously calculated as the angle between the audience and screen is constantly changing. Stereoscopic images can be created by using a pair of computer cameras.

While the invention has been described with respect to a preferred embodiment, the description is not intended to be limiting in any way. Modifications and variations would be apparent to one of ordinary skill in the art without departing from the scope of the invention.

What is claimed is:

1. A method for skewing graphics for viewing at an angle, comprising:
determining the angle between a viewer and a viewing screen, to determine an audience point of view;
mapping the original geometry of an object from said audience point of view;
determining the angle between a projector and said viewing screen to determine a projector point of view; and
translating the original geometry from said audience point of view to a skewed geometry in said projector point of view.

2. The method of claim 1, further comprising performing the method iteratively for an audience moving relative to said viewing screen.

3. The method of claim 1, further comprising rendering the skewed geometry with computer graphic techniques.

4. The method of claim 1, further comprising storing information regarding light positions in the original geometry prior to translating the original geometry to the skewed geometry.

5. Graphics distorted to account for viewing at an angle, said graphics created by:
determining the angle between a viewer and a viewing screen, to determine an audience p oint of view;
mapping the original geometry of an object from said audience point of view;
determining the angle between a projector and said viewing screen to determine a projector point of view; and
translating the original geometry from said audience point of view to a skewed geometry in said projector point of view.

6. The graphics of claim 5, further comprising performing the method iteratively for an audience moving relative to said viewing screen.

7. The graphics of claim 5, further comprising rendering the skewed geometry with computer graphic techniques.

8. The graphics of claim 5, further comprising storing information regarding light positions in the original geometry prior to translating the original geometry to the skewed geometry.
